(19) United States
(12) Patent Application Publication
(10) Pub. No.: US 2025/0370312 A1
(43) Pub. Date: Dec. 4, 2025

(54) MOBILE TERMINAL COVER

(71) Applicant: NIPPON TELEGRAPH AND TELEPHONE CORPORATION, Tokyo (JP)

(72) Inventors: Takuya KANDA, Tokyo (JP); Yasuo ISHIGURE, Tokyo (JP)

(21) Appl. No.: 18/870,752

(22) PCT Filed: Jun. 14, 2022
(86) PCT No.: PCT/JP2022/023863

§ 371 Date: Dec. 2, 2024

(51) Int. Cl. G03B 11/04; G03B 17/56

(52) U.S. Cl. CPC G03B 11/045; G03B 17/565

(57) ABSTRACT

A mobile terminal cover for covering a mobile terminal comprising a camera and a light emitter is configured to form a cylinder for shielding light from a lens of the camera by folding a part of a member in the mobile terminal cover.

### TECHNICAL FIELD

The present invention relates to a cover for a mobile terminal such as a smartphone.

### BACKGROUND ART

In recent years, much research and development on systems for estimating an autonomic nerve activity have been performed. As a technique for estimating an autonomic nerve activity daily, in order to save a user's trouble, a technique that uses a contact sensor to perform estimation without the user's awareness is disclosed in, for example, Patent Literature 1 to Patent Literature 3.

However, many of these techniques require long time measurement for estimating an autonomic nerve activity, which is hard on the user. For this reason, there is a technique for estimating an autonomic nerve activity in a short period of time from dynamic characteristics of light reflection of a pupil.

### CITATION LIST

### Patent Literature

Patent Literature 1: Nippon Telegraph and Telephone Corporation (Japanese Patent Application Laid-open No. 2013-236754)
Patent Literature 2: Nippon Telegraph and Telephone Corporation (Japanese Patent Application Laid-open No. 2019-000283)
Patent Literature 3: Nippon Telegraph and Telephone Corporation (Japanese Patent Application Laid-open No. 2019-154482)

### SUMMARY OF INVENTION

### Technical Problem

In order to estimate an autonomic nerve activity by measuring the dynamic characteristics of the pupil to light reflection, it is conceivable to use a mobile terminal (hereinafter referred to as “smartphone” as the mobile terminal) equipped with a camera and a light (for example, flashing LED light). In this method, the light is emitted to give light stimulation to the pupil, the pupil at that time is photographed by the camera, and the change in the size of the pupil diameter due to the reflection of light is analyzed to estimate an autonomic nerve activity.

However, considering a use case for daily measurement related to the eye using a smartphone, the pupil is affected by the intensity of ambient light during measurement. Therefore, it becomes unknown whether the change in the pupil diameter is due to the ambient light or due to a change in autonomic nerve activity.

The present invention has been made in view of the above point, and an object of the present invention is to provide a technique for reducing the impact of ambient light when measuring an eye by using a mobile terminal.

### Solution to Problem

According to the disclosed technique, there is provided a mobile terminal cover for covering a mobile terminal equipped with a camera and a light emitter, wherein
a part of a member in the mobile terminal cover is folded to form a cylinder for shielding light from a lens of the camera.

### Advantageous Effects of Invention

According to the disclosed technique, there is provided a technique for reducing the impact of ambient light when measuring an eye by using a mobile terminal.

### BRIEF DESCRIPTION OF DRAWINGS

FIG. 1 is a diagram for explaining Example 1.

FIG. 2 is a diagram for explaining Example 1.

FIG. 3 is a diagram for explaining Example 1.

FIG. 4 is a diagram for explaining Example 1.

FIG. 5 is a diagram for explaining Example 1.

FIG. 6 is a diagram for explaining Example 1.

FIG. 7 is a diagram for explaining Example 2.

FIG. 8 is a diagram for explaining Example 2.

FIG. 9 is a diagram for explaining Example 3.

FIG. 10 is a diagram for explaining Example 3.

FIG. 11 is a diagram for explaining Example 4.

FIG. 12 is a diagram for explaining Example 4.

FIG. 13 is a diagram for explaining Example 5.

FIG. 14 is a diagram for explaining Example 5.

FIG. 15 is a diagram for explaining Example 5.

### DESCRIPTION OF EMBODIMENTS

Hereinafter, embodiments of the present invention (the present embodiments) will be described with reference to the drawings. The embodiments to be described hereinafter are merely examples and embodiments to which the present invention is applied are not limited to the following embodiments.

In the following description, a smartphone is used as an example of a mobile terminal having a cover capable of forming a mechanism for shielding an eye from ambient light (a mechanism for shielding a lens of a camera from light), but the cover according to the present invention is applicable to a mobile terminal not limited to the smartphone. Examples of the mobile terminal include, in addition to smartphones, mobile phones that are not smartphones, tablets, and notebook type PCs.

The material of the cover may be any material as long as it can be used as the cover of the mobile terminal. For example, the material of the cover may be selected from metal, glass, plastic, rubber, wood, fabric, paper or the like.

The material of the cover and the material of the member constituting the mechanism for shielding the eye from ambient light may be the same or different. The material of the member constituting the mechanism for shielding the eye from ambient light may be selected from metal, glass, plastic, rubber, wood, fabric, paper or the like.

### Overview of Embodiments

It is known that daily understanding of autonomic nerve activities is useful in management of mental and physical health.

It is also known that a pupil is one of the organs known to be deeply related to autonomic nerve activity, and that the size of the pupil is changed by a change in autonomic nerve activity. It is known that the size of the pupil varies depending on the amount of light applied to the eye, but the variation is not constant even if the amount of light is the same, and the size of the pupil changes depending on the state of autonomic nerve activity.

Therefore, daily measurement of the pupil leads to a daily understanding of autonomic nerve activity, and is effective in management of mental and physical health. A camera mounted on the smartphone is useful as a sensor for measuring the pupil on a daily basis.

On the other hand, considering a use case where measurement related to the eye is performed daily by using a smartphone, the pupil is affected by the intensity of ambient light during the measurement, and it becomes unknown whether a change in the size of the pupil diameter is due to the ambient light or a change in autonomic nerve activity.

In order to eliminate such an impact of ambient light, it is conceivable to attach a mechanism for blocking the eye from ambient light to the smartphone in the same manner as the conventional pupil measuring apparatus. However, carrying such a mechanism and attaching it to a smartphone for every measurement could greatly impair the convenience for the user.

In order to solve the above problem, according to the present embodiment, as a mechanism (light shielding mechanism) for shielding ambient light during pupil measurement using a smartphone, a smartphone cover equipped with a fold mechanism for the purpose of propping up the smartphone is used.

That is, by devising a way of folding the smartphone cover for propping up the smartphone by folding, a mechanism for blocking ambient light from the pupil during pupil measurement using a camera on the rear surface of the smartphone is realized.

Thus, the smartphone cover applicable to pupil measurement while maintaining the portability equivalent to that of a conventional smartphone cover can be realized. Hereinafter, examples of a configuration of said smartphone cover will be described with reference to Examples 1 to 5.

### Example 1

Example 1 describes a basic configuration example of a smartphone cover 100 that is provided with a mechanism capable of blocking the impact of ambient light, which becomes noise, when measuring a pupil using a light (may also be referred to as a light emitter) mounted on a smartphone.

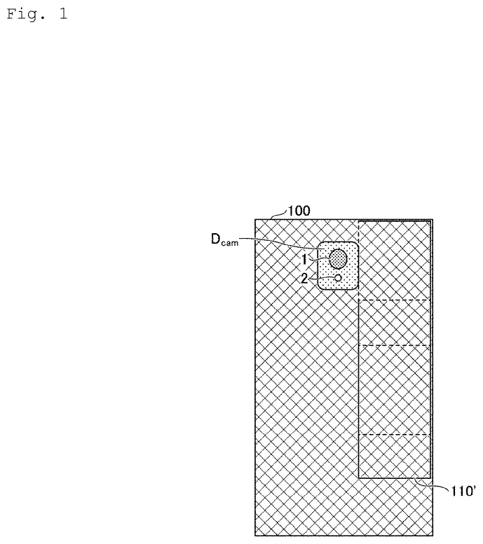

FIG. 1 is a diagram showing an example of the smartphone cover 100 which is attached to the smartphone and viewed from the side of the surface of the smartphone where a camera is located. The dotted line on the surface of the smartphone cover 100 in FIG. 1 indicates a valley fold line, and the solid line indicates a cutoff line.

The smartphone cover 100 has a fold mechanism and a separation mechanism, and by using these mechanisms, a cylindrical part 110 can be provided which cylindrically covers an eye of a user and a camera area D_{cam} having a camera 1 mounted on the rear surface of the smartphone and a flashing light 2.

The part of the smartphone cover 100 before being assembled as the cylindrical part 110 is referred to as a cylindrical part formation part 110′. In the example shown in FIG. 1, approximately an upper end of the smartphone is an upper end of the cylindrical part formation part 110′, but this is an example. A part separated from the upper end of the smartphone may be the upper end of the cylindrical part formation part 110′. The upper end is a cutoff line.

The camera area D_{cam} is a part of a structure in which the camera 1 and the light 2 are put together, which is usually provided in a smartphone, but is not limited thereto.

The separation mechanism means that the cylindrical part formation part 110′ is separated (removed) from a part of the smartphone cover 100 that covers the smartphone. However, when the cylindrical part 110 is formed from the cylindrical part formation part 110′, the smartphone may be exposed at a part where the cylindrical part formation part 110′ was located.

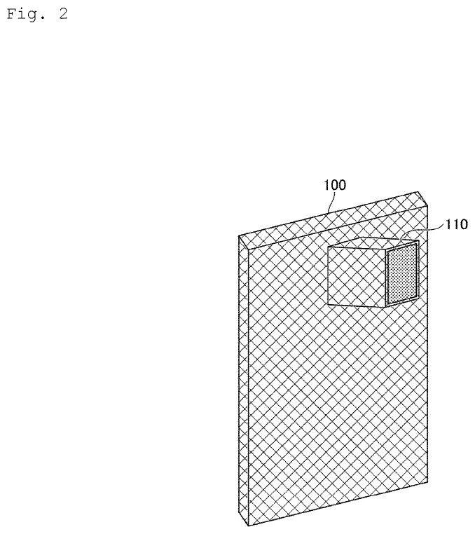

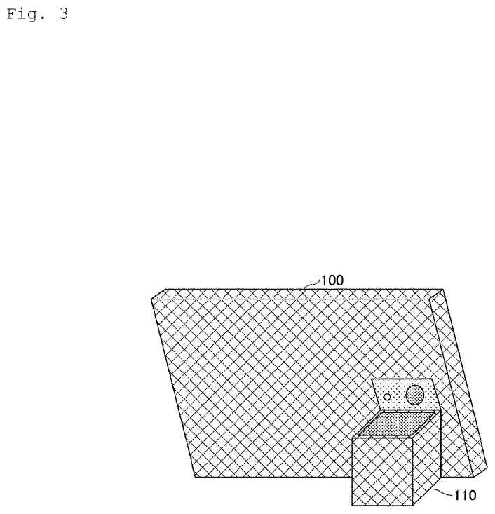

FIG. 2 shows an example of the smartphone cover 100 in a state where the cylindrical part 110 is formed by using the fold mechanism and the separation mechanism. By tilting the cylindrical part 110 outward (the right-hand side in FIG. 2) with the valley fold line as the boundary between the cylindrical part 110 and the camera area D_{cam}, the cylindrical part 110 can be used as a stand mechanism of the smartphone, as shown in FIG. 3.

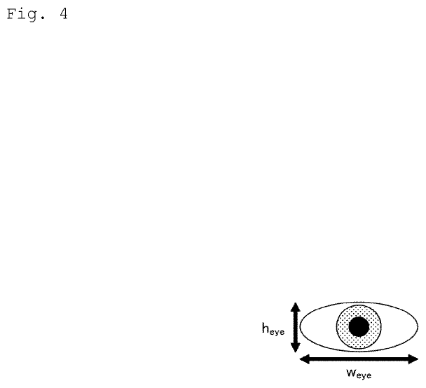

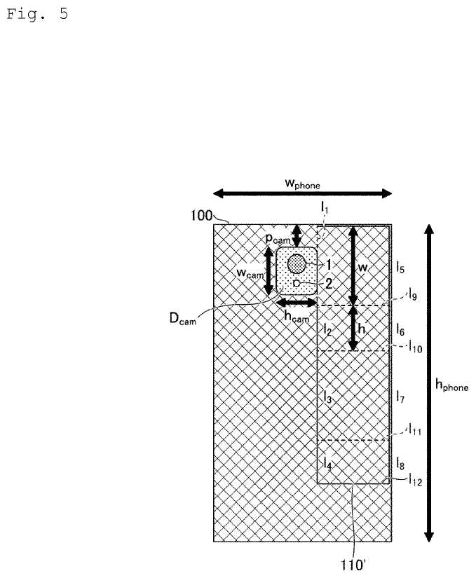

Here, as shown in FIG. 4, the lateral width of the eye of the user of the smartphone is denoted as w_{eye}, and the longitudinal width as h_{eye}. Further, as shown in FIG. 5, the lateral width and the longitudinal width of a part here the cylindrical part 110 is folded into a cylindrical shape are denoted as w and h.

The example shown in FIG. 5 assumes that the smartphone with the smartphone cover 100 is used in a horizontal state when measuring the light reflection of the pupil, and therefore, in a state where the smartphone is assembled as the cylindrical part 110, the width of the cylindrical part 110 in a direction parallel to the longer side of the smartphone is defined as “lateral width,” and the width of the cylindrical part 110 in a direction substantially perpendicular to the lateral width is defined as “longitudinal width.” However, this is an example, so the “lateral width” and the “longitudinal width” in the cylindrical part 110 may be opposite to those shown in FIG. 5. That is, w in the cylindrical part formation part 110′ in FIG. 5 may be h and h may be w.

Further, the lateral width of the camera area D_{cam} is denoted as w_{cam}, and the longitudinal width thereof as h_{cam}. The lateral width of the smartphone is denoted as wₚₕₒₙₑ, the longitudinal width as hₚₕₒₙₑ, and the distance between the smartphone upper end and the D_{cam} upper end as pram (<hₚₕₒₙₑ/2).

To realize a cylindrical part 110 capable of not only simultaneously covering the eye and the part D_{cam} having the camera 1 and the light 2 but also propping up the smartphone, w_{cam}, h_{cam}, wₚₕₒₙₑ, hₚₕₒₙₑ, and p_{cam} described above are defined.

The lateral width w and the longitudinal width h of the cylindrical part 110 are determined by the lateral width w_{eye} and the longitudinal width h_{eye} of the eye and the longitudinal ham and the lateral width w_{cam} of the area D_{cam} of the smartphone.

The w and h satisfy the following conditions, since both the eye of the user and the D_{cam} can be covered and a member (cylindrical part formation part 110′) before assembled as the cylindrical part 110 needs to be within a range of height of the smartphone.

$$w >= {w}_{eye}$$

$$w >= {w}_{cam}$$

$$h >= {h}_{eye}$$

$$h >= {h}_{cam}$$

$$2 ( w + h ) <= {h}_{phone}$$

FIG. 5 shows symbols of the cutoff line and the valley fold line in the smartphone cover 100. In FIGS. 5, l₃ to l₈ and l₁₂ indicate cutoff lines, and l₁ and l₉ to l₁₁ indicate valley fold lines.

For example, in the case shown in FIG. 5, if the length of the p_{cam} is greater than the length of the l₁, the cylindrical part 110 cannot cover the area D_{cam}.

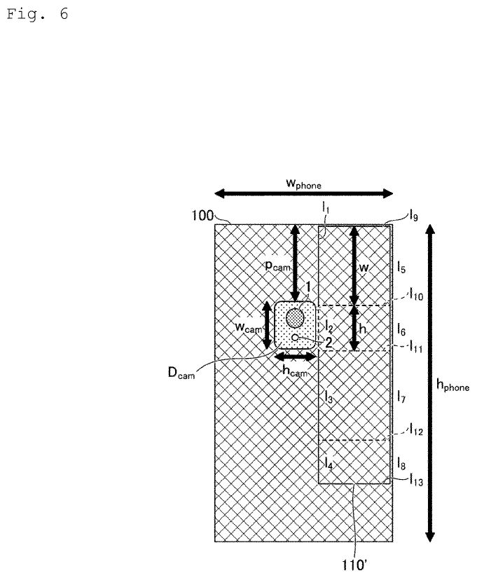

Therefore, in this example, whether the lines l₁ and l₂ are the cutoff lines or valley fold lines is determined according to the sizes of the p_{cam} and the hₚₕₒₙₑ. Specifically, in the case where p_{cam}+2w+h<=hₚₕₒₙₑ, l₁ is a valley fold line and l₂ is a cutoff line. In the case where p_{cam}+2w+h>hₚₕₒₙₑ, l₁ is a cutoff line and l₂ is a valley fold line. FIG. 6 shows a smartphone cover in the case where l₁ is a cutoff line and _{L}2 is a valley fold line. As shown in the example of FIG. 6, when w and h are used, it is assumed that the measurement is performed with the smartphone placed vertically.

A folding structure of a member (cylindrical part formation part 110′) in the smartphone cover for constituting the cylindrical part 110 shown in Example 1 is an example. Any structure may be adopted as long as the structure allows the smartphone stand on its own by folding and can shield environmental light. For example, the folding structure may be designed symmetrically with respect to the center of the smartphone.

Further, the smartphone with the smartphone cover in Example 1 is not limited to light reflex, but any type of smartphone may be used as long as it is related to an eye and needs to consider the impact of ambient light such as an eye-fundus image and iris. Further, any method may be used for turning on the switch for photographing.

In Example 1, the cylindrical part 110 is formed in the shape of a quadrangular prism, but this shape may be circular or elliptical. In other words, the cylindrical part formation part 110′ may be constituted so that the cylindrical part 110 is a cylindrical or elliptical column.

### Example 2

Example 2 will be described next. Example 2 is based on Example 1, and mainly the differences with Example 1 will be described below.

In Example 2, magnets are provided in a part of the cylindrical part formation part 110′ in the smartphone cover 100 and a part of a part other than the cylindrical part formation part 110′ in the smartphone cover 100. Thus, the safety of the assembled cylindrical part 110 can be improved.

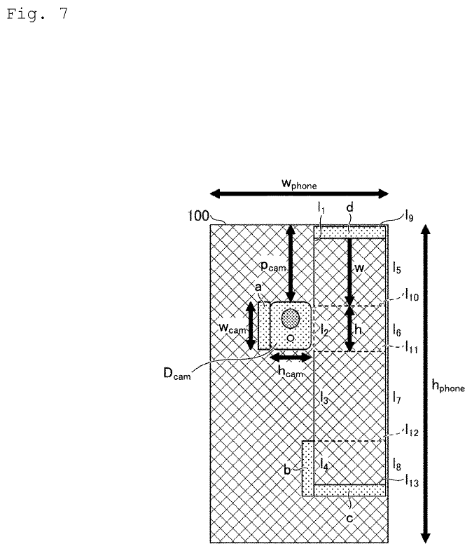

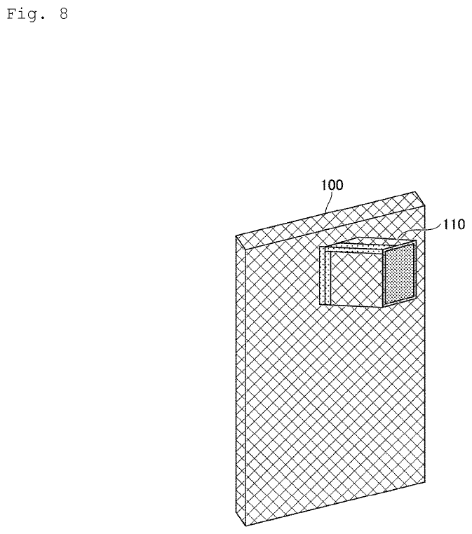

FIG. 7 shows a configuration example of the smartphone cover 100 to which magnets are added. FIG. 7 shows a case where l₁ is a cutoff line, for example. As shown in FIG. 7, magnets a, b, c, and d are added. The magnets a and b in the cylindrical part formation part 110′ are bonded by magnetic force when assembled to the cylindrical part 110, and the magnets c and b are also bonded by magnetic force. FIG. 8 shows a configuration example in which the cylindrical part 110 is assembled from the cylindrical part formation part 110′.

After the cylindrical part 110 is constituted by folding the cylindrical part formation part 110′ in the smartphone cover, for example, the measurement of the pupil can be performed while maintaining the cylindrical shape by hand.

However, the user may feel frustrated when maintaining the cylindrical shape by hand. Therefore, in Example 2, the stability of the assembly part can be improved by attaching the magnets to a part of the smartphone cover 100, as shown in FIG. 7.

FIG. 7 shows an example of how the magnets are attached. Any method of sticking the magnets may be used as long as the stability of the cylindrical shape is improved.

Further, the member for bonding is not limited to the magnets. For example, a Velcro® may be used instead of or in addition to the magnets. Members other than the magnets and a Velcro® may be used as long as the stability of the cylindrical shape can be improved. Members for bonding such as magnets and Velcro® may be generically called adhesive members.

### Example 3

Example 3 will be described below. Example 3 is based on Example 1, and mainly the differences with Example 1 will be described below. Note that Example 3 and Example 2 may be combined and implemented.

Since most materials of smartphone covers are typically hard, the user may feel discomfort when placing the cylindrical part 110 made of such material on the eye.

Using a soft material as the material of the smartphone cover in order to alleviate discomfort caused by the hardness may reduce the strength of the cylindrical part 110 and the stability of propping up the smartphone, thereby the function of the cylindrical part 110 as a smartphone stand cannot be realized. In addition, if a new mechanism of an eyepiece structure is attached for the mere purpose of reducing the discomfort, portability becomes impaired.

Therefore, Example 3 employs a ring part that is formed of a soft material such as silicon in a ring strap conventionally attached to a smartphone cover.

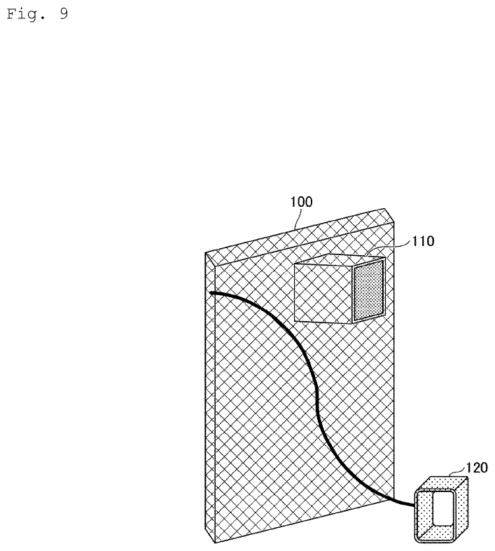

FIG. 9 shows a configuration example of the smartphone cover 100 according to Example 3. FIG. 9 shows a state in which the cylindrical part 110 has already been assembled. As shown in FIG. 9, a ring part 120 of a ring strap has a shape that can be mounted on the cylindrical part 110.

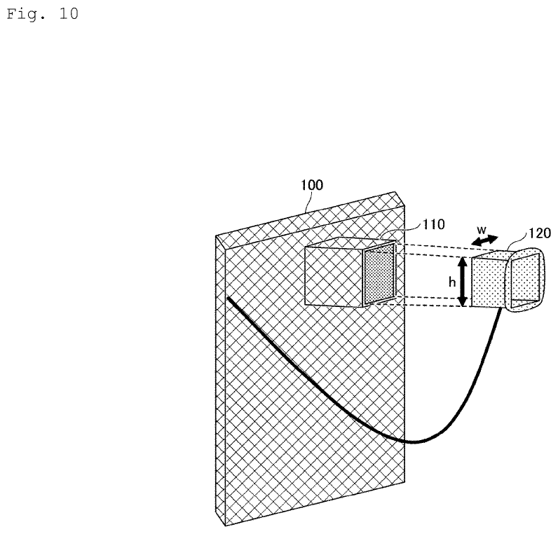

As shown in FIG. 10, the ring part 120 is constructed such that the inside square dimension of the ring part 120 is equal to the outside square dimension w×h of the cylindrical part 110. The height of the ring part 120 from the surface of the smartphone cover 100 when the ring part 120 is attached is made higher than the height of the cylindrical part 110. By attaching the ring part 120 having such a structure to the cylindrical part 110 like an eye piece, the soft ring part 120 comes into contact with the periphery of the eye, so that discomfort during measurement can be reduced. The ring part 120 may be referred to as a “cover.”

### Example 4

Example 4 will be described below. Example 4 may be applied to the smartphone cover 100 (the shape before assembling the cylindrical part 110) having the configuration of Examples 1, 2, or may be applied to a smartphone cover not having the configuration of Examples 1, 2.)

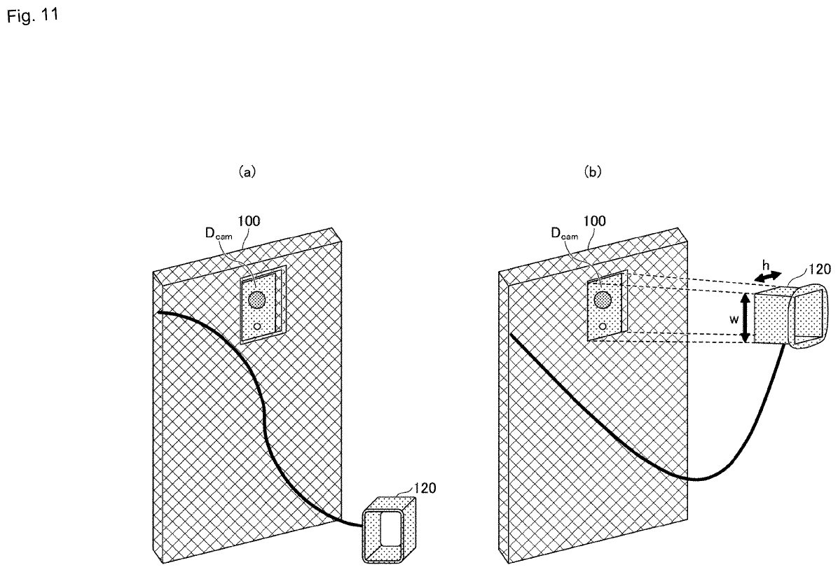

In Example 4, as shown in FIGS. 11(a) and 11(b), by devising the structure of the smartphone cover 100 around the camera area D_{cam} of the smartphone, the ring part 120 of the ring strap of the smartphone in Example 3 can be attached to the smartphone cover 100, and achieves a hood-type mechanism (a mechanism for blocking ambient light from the eyes) is realized.

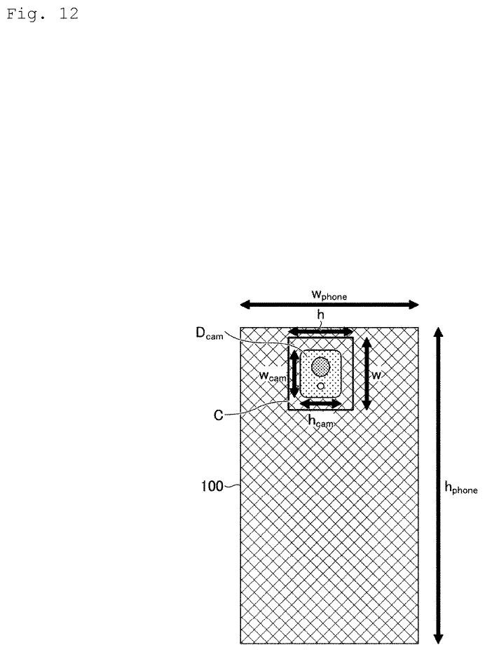

More specifically, as shown in FIG. 12, the structure of the hood-type mechanism is realized by adding a groove C to which the ring part 120 can be attached to the smartphone cover 100.

The longitudinal and lateral dimensions w×h of the ring part 120 shown in FIG. 11(b) are matched with the dimensions w×h of the groove C. As in the cylindrical part 110 of Example 1, the ring part 120 needs to cover both the eye and the camera area D_{cam} but does not need to be folded, so that the conditions of C in Example 4 and of w and h in the ring part 120 are as follows.

$$w >= {w}_{eye}$$

$$w >= {w}_{cam}$$

$$h >= {h}_{eye}$$

$$h >= {h}_{cam}$$

### Example 5

Example 5 will be described below. Example 5 can be implemented in combination with any of Examples 1 to 4.

In Example 5, a macro lens is attached to the smartphone cover 100 so as to cover the lens in the camera area D_{cam} of the smartphone, whereby the pupil can be more clearly photographed. The macro lens can be attached or detached as necessary.

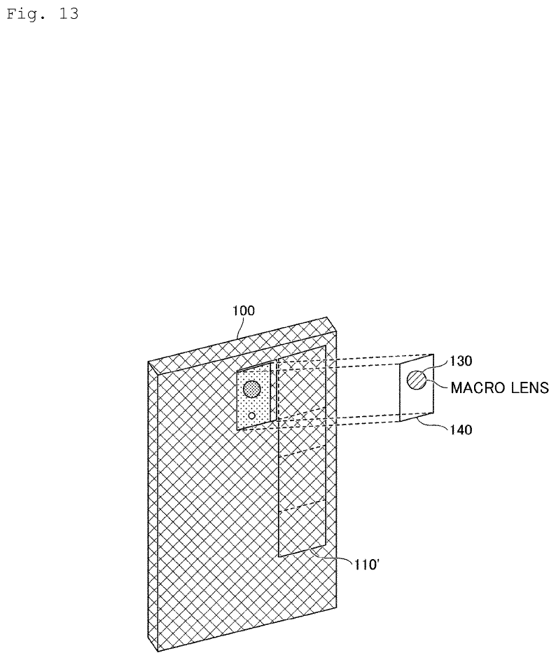

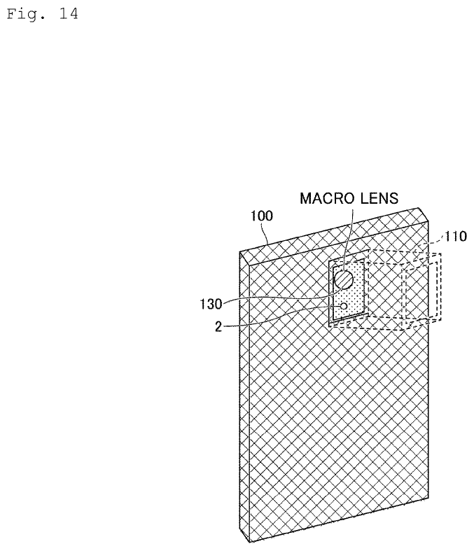

FIG. 13 is a diagram showing that a member 140 having a macro lens 130 is attached to a part of the camera area D_{cam} in the smartphone cover 100. FIG. 14 is a diagram showing that the macro lens 130 is provided in a state in which the cylindrical part 110 is assembled. In FIG. 14, the ring part 120 of Example 4 may be used instead of the cylindrical part 110.

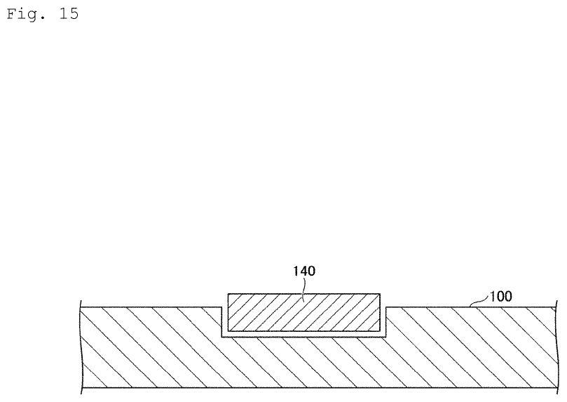

Any method may be used for attaching the member 140 having the macro lens 130 to the smartphone cover 100. For example, as shown in FIG. 15 (a cross-sectional view of the smartphone cover 100), the member 140 may be fitted into a recess in the part of the camera area D_{cam} in the smartphone cover 100.

A camera of a general smartphone is for long shots and not for close-up photography. Therefore, as described above, in Example 5, the member 140 having the macro lens 130 of the same size as the camera area D_{cam} is attached to the camera area D_{cam} of the smartphone. Thus, the image of the pupil can be more clearly photographed by close-up photographing.

### Effects of Embodiments

According to the technique according to the present embodiment, it is possible to reduce the impact of ambient light when measuring the eye using the mobile terminal.

### Additional Remarks

The present specification discloses a mobile terminal cover described in at least the following clauses.

### Clause 1

A mobile terminal cover for covering a mobile terminal comprising a camera and a light emitter, the mobile terminal cover being configured to form a cylinder for shielding light from a lens of the camera by folding a part of a member of the mobile terminal cover.

### Clause 2

The mobile terminal cover according to clause 1, wherein a part of the member is provided with an adhesive member for stabilizing the cylinder.

### Clause 3

The mobile terminal cover according to clause 1 or 2, comprising a strap connected to the mobile terminal cover, and a cover connected to the strap, wherein the cover is made of a material softer than the member, and is configured to be attachable to the cylinder.

### Clause 4

The mobile terminal cover according to any one of clauses 1 to 3, further comprising a mechanism for fitting a close-up macro lens so as to cover the lens of the camera.

Although the embodiments have been described above, the present invention is not limited to a specific embodiment, and various modifications and changes can be made within the scope of the gist of the present invention described in the claims.

### REFERENCE SIGNS LIST

1 Lens
2 Light
100 Smartphone cover
110 Cylindrical part
110 Cylindrical part formation part
120 Ring part
130 Macro lens
140 Member

1. A mobile terminal cover for covering a mobile terminal comprising a camera and a light emitter,
the mobile terminal cover being configured to form a cylinder for shielding light from a lens of the camera by folding a part of a member of the mobile terminal cover.

2. The mobile terminal cover according to claim 1, wherein a part of the member is provided with an adhesive member for stabilizing the cylinder.

3. The mobile terminal cover according to claim 1, comprising a strap connected to the mobile terminal cover, and a cover connected to the strap, wherein the cover is made of a material softer than the member, and is configured to be attachable to the cylinder.

4. The mobile terminal cover according to claim 1, further comprising a mechanism for fitting a close-up macro lens so as to cover the lens of the camera.
